(19) United States
(12) Patent Application Publication
(10) Pub. No.: US 2026/0012239 A1
(43) Pub. Date: Jan. 8, 2026

(54) CHANNEL STATE INFORMATION (CSI) REPORTING FOR SECONDARY CELL (SCELL) PHYSICAL UPLINK CONTROL CHANNEL (PUCCH) ACTIVATION

(71) Applicant: APPLE INC., Cupertino, CA (US)

(72) Inventors: Jie CUI, San Jose, CA (US); Yang Tang, San Jose, CA (US); Dawei Zhang, Saratoga, CA (US); Qiming LI, Beijing (CN); Manasa RAGHAVAN, Sunnyvale, CA (US); Rolando E. BETTANCOURT ORTEGA, Munich (DE); Xiang CHEN, Campbell, CA (US); Yuexia SONG, Beijing (CN); Hong HE, San Jose, CA (US)

(73) Assignee: APPLE INC., Cupertino, CA (US)

(21) Appl. No.: 19/112,882

(22) PCT Filed: Sep. 21, 2021
(86) PCT No.: PCT/CN2022/120351

§ 371 Date: Mar. 18, 2025

(51) Int. Cl. H04B 7/06; H04B 17/318; H04W 72/21

(52) U.S. Cl. CPC H04B 7/0626; H04B 7/0632; H04B 17/328; H04W 72/21

(57) ABSTRACT

Some aspects of this disclosure relate to apparatuses and methods for implementing channel state information (CSI) reporting during activation of a physical uplink control channel (PUCCH) for a secondary cell (SCell). For example, a user equipment (UE) may implement a reporting mechanism that uses multiple PUCCH groups to report CSI measurements. The UE may indicate whether it is capable of reporting a CSI measurements for the SCell on a first PUCCH group corresponding to a primary cell (PCell) or primary secondary cell (PSCell) as well as on a second PUCCH group corresponding to the SCell. Depending on the UE's capabilities, the network may configure the PUCCH groups for the UE to use to report CSI measurements during activation of the SCell PUCCH.

### BACKGROUND

### Field

The described aspects generally relate to mechanisms for a user equipment (UE) to report channel state information (CSI) corresponding to a secondary cell (SCell) during activation of the physical uplink control channel (PUCCH) of the SCell.

### Related Art

In some examples, a user equipment (UE) may connect with a network via a base station to initiate wireless communications. One way that this connection may arise is through carrier aggregation. When a network and a UE are communicating via carrier aggregation, two network cells serviced by respective base stations may communicate with the UE. For example, the UE may communicate with a primary cell (PCell) and then activate a secondary cell (SCell) to operate in a carrier aggregation mode. This allows the UE to communicate with the PCell and the SCell simultaneously. Ambiguities arise, however, during the activation process of the SCell and a physical uplink control channel (PUCCH) for the SCell. For example, it is unclear how the UE should report channel state information (CSI) for the SCell. The SCell may provide reference signals for measurement during activation of the SCell PUCCH, but the UE may not be able to report this CSI information to the SCell.

### SUMMARY

Some aspects of this disclosure relate to apparatuses and methods for implementing CSI reporting for a SCell during activation of the SCell PUCCH. For example, some aspects of this disclosure relate to apparatuses and methods for implementing a reporting mechanism at a UE where the UE indicates whether it is capable of separating CSI reporting into multiple PUCCH groups. For example, the UE may indicate whether it is capable of reporting a CSI measurements for the SCell on a first PUCCH group corresponding to a PCell or primary secondary cell (PSCell) as well as on a second PUCCH group corresponding to the SCell. Depending on the UE's capabilities, the network may configure the PUCCH groups for the UE to use to report CSI measurements during activation of the SCell PUCCH.

Some aspects of this disclosure relate to a primary cell base station. The primary cell base station includes a transceiver configured to enable wireless communication with a user equipment (UE). The transceiver receives wireless communications from the UE via a physical uplink control channel (PUCCH). The primary cell base station also includes a processor communicatively coupled to the transceiver. The processor can be configured to receive, from the UE, a message indicating whether the UE supports separating reporting of channel state information (CSI). Based on the message indicating that the UE supports separating the reporting of CSI, the processor is further configured to allocate a first PUCCH group for the UE to report a first CSI measurement of a first CSI resource associated with a secondary cell base station during activation of the secondary cell base station. The processor is further configured to allocate a second PUCCH group for the UE to report a second CSI measurement of a second CSI resource associated with the secondary cell base station during activation of the secondary cell base station. The processor is further configured to transmit, to the UE, an identification of the first PUCCH group and the second PUCCH group.

In some aspects, the first PUCCH group corresponds to the primary cell base station and the second PUCCH group corresponds to the secondary cell base station.

In some aspects, the first PUCCH group corresponds to the primary cell base station and the first CSI measurement is a layer-1, reference signal received power (L1-RSRP) measurement.

In some aspects, the second PUCCH group corresponds to the secondary cell base station and wherein the second CSI measurement is a channel quality indicator (CQI).

In some aspects, based on the message indicating that the UE does not support separating the reporting of CSI, the processor is configured to allocate a PUCCH group corresponding to the primary cell base station for the UE to report a CSI measurement of a CSI resource associated with the secondary cell base station during activation of the secondary cell. The processor is further configured to transmit, to the UE, an identification of the PUCCH group.

In some aspects, based on the message indicating that the UE does not support separating the reporting of CSI, the processor is configured to allocate a first PUCCH group corresponding to the primary cell base station for the UE to report a layer-1, reference signal received power (L1-RSRP) measurement associated with the secondary cell base station during activation of the secondary cell. The processor is further configured to allocate a second PUCCH group corresponding to the secondary cell base station for the UE to report a channel quality indicator (CQI) measurement associated with the secondary cell base station. The processor is further configured to transmit, to the UE, an identification of the first PUCCH group and receive a report from the UE that the L1-RSRP measurement is a non-lowest index value. In response to receiving the report of the L1-RSRP measurement, the processor is further configured to transmit, to the UE, an identification of the second PUCCH group.

In some aspects, based on the message indicating that the UE does not support separating the reporting of CSI, the processor is configured to allocate a first PUCCH group corresponding to the primary cell base station for the UE to report a layer-1, reference signal received power (L1-RSRP) measurement associated with the secondary cell base station during activation of the secondary cell. The processor is further configured to allocate a second PUCCH group corresponding to the secondary cell base station for the UE to report a channel quality indicator (CQI) measurement associated with the secondary cell base station. The processor is further configured to transmit, to the UE, an identification of the first PUCCH group and the second PUCCH group, wherein the UE is configured to transmit the CQI measurement using the second PUCCH group after the UE has reported a non-lowest index value for the L1-RSRP measurement using the first PUCCH group.

In some aspects, based on the message indicating that the UE does not support separating the reporting of CSI, the processor is configured to allocate a first PUCCH group corresponding to the primary cell base station for the UE to report a layer-1, reference signal received power (L1-RSRP) measurement associated with the secondary cell base station during activation of the secondary cell. The processor is further configured to allocate a second PUCCH group corresponding to the secondary cell base station for the UE to report a channel quality indicator (CQI) measurement associated with the secondary cell base station. The processor is further configured to transmit, to the UE, an identification of the first PUCCH group and the second PUCCH group, wherein the UE is configured to, after the UE has reported a non-lowest index value for the L1-RSRP measurement on the first PUCCH group, report the CQI measurement using the first PUCCH group if the CQI measurement is an out of range value and transmit the CQI measurement using the second PUCCH group if the CQI measurement is not an out of range value.

Some aspects of this disclosure relate to a method performed by a primary cell including receiving, at a primary cell from a user equipment (UE), a message indicating whether the UE supports separating reporting of channel state information (CSI). Based on the message indicating that the UE supports separating the reporting of CSI, the method further includes allocating, by the primary cell, a first PUCCH group for the UE to report a first CSI measurement of a first CSI resource associated with a secondary cell during activation of the secondary cell. The method further includes allocating, by the primary cell, a second PUCCH group for the UE to report a second CSI measurement of a second CSI resource associated with the secondary cell during activation of the secondary cell. The method further includes transmitting, by the primary cell to the UE, an identification of the first PUCCH group and the second PUCCH group.

Some aspects of this disclosure relate to a user equipment (UE). The UE includes a transceiver configured to wirelessly communicate with a primary cell and a secondary cell and a processor communicatively coupled to the transceiver. The processor can be configured to determine whether the UE supports separating reporting of channel state information (CSI). Based on the UE supporting separating the reporting of CSI, the processor is further configured to transmit a message to the primary cell indicating that the UE supports separating the reporting of CSI. The processor is further configured to receive an allocation of a first physical uplink control channel (PUCCH) group and a second PUCCH group. The processor is further configured to report, using the first PUCCH group, a first CSI measurement of a first CSI resource associated with a secondary cell during activation of the secondary cell and report, using the second PUCCH group, a second CSI measurement of a second CSI resource associated with the secondary cell during activation of the secondary cell.

In some aspects, the first PUCCH group corresponds to the primary cell and the second PUCCH group corresponds to the secondary cell.

In some aspects, the first PUCCH group corresponds to the primary cell and the first CSI measurement is a layer-1, reference signal received power (L1-RSRP) measurement.

In some aspects, the second PUCCH group corresponds to the secondary cell and the second CSI measurement is a channel quality indicator (CQI).

Some aspects of this disclosure relate to a primary cell base station. The primary cell base station includes a transceiver configured to enable wireless communications with a user equipment (UE). The transceiver receives wireless communications from the UE via a physical uplink control channel (PUCCH). The primary cell base station also includes a processor communicatively coupled to the transceiver. The processor can be configured to receive, from the UE, a message indicating whether the UE supports separating reporting of channel state information (CSI). Based on the message indicating that the UE supports separating the reporting of CSI, the processor is further configured to allocate a first PUCCH group for the UE to report a CSI measurement of a CSI resource associated with a secondary cell base station during activation of the secondary cell base station based on the CSI measurement meeting a first condition. The processor is further configured to allocate a second PUCCH group for the UE to report the CSI measurement of the CSI resource associated with the secondary cell base station during activation of the secondary cell base station based on the CSI measurement meeting a second condition. The processor is further configured to transmit, to the UE, an identification of the first PUCCH group and the second PUCCH group.

In some aspects, the first PUCCH group corresponds to the primary cell base station and the second PUCCH group corresponds to the secondary cell base station.

In some aspects, the CSI measurement is a channel quality indicator (CQI) and the first condition corresponds to an out of range CQI value; or the CSI measurement is a layer-1, reference signal received power (L1-RSRP) measurement and the first condition corresponds to a lowest index of L1-RSRP.

In some aspects, the CSI measurement is a channel quality indicator (CQI) and the second condition corresponds to a valid or non out of range CQI value; or the CSI measurement is a layer-1, reference signal received power (L1-RSRP) measurement and the second condition corresponds to a non-lowest index of L1-RSRP.

In some aspects, based on the message indicating that the UE does not support separating the reporting of CSI, the processor is configured to allocate a PUCCH group corresponding to the primary cell base station for the UE to report a CSI measurement of a CSI resource associated with the secondary cell base station during activation of the secondary cell. The processor is further configured to transmit, to the UE, an identification of the PUCCH group.

In some aspects, based on the message indicating that the UE does not support separating the reporting of CSI, the processor is configured to allocate allocate a first PUCCH group corresponding to the primary cell base station for the UE to report a layer-1, reference signal received power (L1-RSRP) measurement associated with the secondary cell base station during activation of the secondary cell. The processor is further configured to allocate a second PUCCH group corresponding to the secondary cell base station for the UE to report a channel quality indicator (CQI) measurement associated with the secondary cell base station. The processor is further configured to transmit, to the UE, an identification of the first PUCCH group and receive a report from the UE that the L1-RSRP measurement is a non-lowest index value. In response to receiving the report of the L1-RSRP measurement, the processor is further configured to transmit, to the UE, an identification of the second PUCCH group.

In some aspects, based on the message indicating that the UE does not support separating the reporting of CSI, the processor is configured to allocate a first PUCCH group corresponding to the primary cell base station for the UE to report a layer-1, reference signal received power (L1-RSRP) measurement associated with the secondary cell base station during activation of the secondary cell. The processor is further configured to allocate a second PUCCH group corresponding to the secondary cell base station for the UE to report a channel quality indicator (CQI) measurement associated with the secondary cell base station. The processor is further configured to transmit, to the UE, an identification of the first PUCCH group and the second PUCCH group, wherein the UE is configured to transmit the CQI measurement using the second PUCCH group after the UE has reported a non-lowest index value for the L1-RSRP measurement using the first PUCCH group.

In some aspects, based on the message indicates that the UE does not support separating the reporting of CSI, the processor is configured to allocate a first PUCCH group corresponding to the primary cell base station for the UE to report a layer-1, reference signal received power (L1-RSRP) measurement associated with the secondary cell base station during activation of the secondary cell. The processor is further configured to allocate a second PUCCH group corresponding to the secondary cell base station for the UE to report a channel quality indicator (CQI) measurement associated with the secondary cell base station. The processor is further configured to transmit, to the UE, an identification of the first PUCCH group and the second PUCCH group, wherein the UE is configured to, after the UE has reported a non-lowest index value for the L1-RSRP measurement on the first PUCCH group, report the CQI measurement using the first PUCCH group if the CQI measurement is an out of range value and transmit the CQI measurement using the second PUCCH group if the CQI measurement is not an out of range value.

Some aspects of this disclosure relate to a method performed by a primary cell including receiving, at a primary cell from a user equipment (UE), a message indicating whether the UE supports separating reporting of channel state information (CSI). Based on the message indicating that the UE supports separating the reporting of CSI, the method further includes allocating, by the primary cell, a first PUCCH group for the UE to report a CSI measurement of a CSI resource associated with a secondary cell during activation of the secondary cell based on the CSI measurement meeting a first condition. The method further includes allocating, by the primary cell, a second PUCCH group for the UE to report the CSI measurement of the CSI resource associated with the secondary cell during activation of the secondary cell based on the CSI measurement meeting a second condition. The method further includes transmitting, by the primary cell to the UE, an identification of the first PUCCH group and the second PUCCH group.

Some aspects of this disclosure relate to a user equipment (UE). The UE includes a transceiver configured to wirelessly communicate with a primary cell and a secondary cell and a processor communicatively coupled to the transceiver. The processor can be configured to determine whether the UE supports separating reporting of channel state information (CSI). Based on the UE supporting separating the reporting of CSI, the processor is further configured to transmit a message to the primary cell indicating that the UE supports separating the reporting of CSI. The processor is further configured to receive an allocation of a first physical uplink control channel (PUCCH) group and a second PUCCH group. Based on a CSI measurement of a CSI resource associated with the secondary cell meeting a first condition, the processor is further configured to report the CSI measurement using the first PUCCH group. Based on the CSI measurement of the CSI resource associated with the secondary cell meeting a second condition, the processor is further configured to report the CSI measurement using the second PUCCH group.

In some aspects, the first PUCCH group corresponds to the primary cell and the second PUCCH group corresponds to the secondary cell.

In some aspects, the CSI measurement is a channel quality indicator (CQI) and the first condition corresponds to an out of range CQI value.

In some aspects, the CSI measurement is a channel quality indicator (CQI) and the second condition corresponds to a valid or non out of range CQI value.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1A illustrates an example system implementing CSI reporting for SCell PUCCH activation, according to some aspects of the disclosure.

FIG. 1B illustrates an example system implementing CSI reporting for SCell PUCCH activation with base stations, according to some aspects of the disclosure.

FIG. 2 illustrates a block diagram of an example system of an electronic device implementing CSI reporting for SCell PUCCH activation, according to some aspects of the disclosure.

FIG. 3A illustrates an example method for a system (for example, a base station) allocating two PUCCH groups for a UE to report CSI measurements corresponding to an SCell, according to some aspects of the disclosure.

FIG. 3B illustrates an example method for a system (for example, a UE) reporting CSI measurements corresponding to an SCell using two PUCCH groups, according to some aspects of the disclosure.

FIG. 4A illustrates an example method for a system (for example, a base station) allocating two PUCCH groups for a UE to report CSI measurements corresponding to an SCell based on one or more conditions, according to some aspects of the disclosure.

FIG. 4B illustrates an example method for a system (for example, a UE) reporting CSI measurements corresponding to an SCell using two PUCCH groups based on one or more conditions, according to some aspects of the disclosure.

FIG. 5 illustrates an example method for a system (for example, a base station) allocating a PCell PUCCH group for a UE to report CSI measurements when the UE is not capable of report separation, according to some aspects of the disclosure.

FIG. 6 illustrates an example method for a system (for example, a base station) allocating two PUCCH groups for a UE to report CSI measurements based on the type of CSI measurement when the UE is not capable of report separation, according to some aspects of the disclosure.

FIG. 7 illustrates an example method for a system (for example, a base station) allocating two PUCCH groups and preconfiguring a UE to report CSI measurements based on the type of CSI measurement when the UE is not capable of report separation, according to some aspects of the disclosure.

FIG. 8 illustrates an example method for a system (for example, a base station) allocating two PUCCH groups for a UE to report CSI measurements based on the value of the CSI measurement when the UE is not capable of report separation, according to some aspects of the disclosure.

FIG. 9 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to apparatuses and methods for implementing CSI reporting for a SCell during activation of the SCell PUCCH. For example, some aspects of this disclosure relate to apparatuses and methods for implementing a reporting mechanism at a UE where the UE indicates whether it is capable of separating CSI reporting into multiple PUCCH groups. For example, the UE may indicate whether it is capable of reporting a CSI measurements for the SCell on a first PUCCH group corresponding to a PCell as well as on a second PUCCH group corresponding to the SCell. Depending on the UE's capabilities, the network may configure the PUCCH groups for the UE to use to report CSI measurements during activation of the SCell PUCCH.

In some examples, the aspects of this disclosure can be performed by a network and/or a UE that operates according to 5″ generation (5G) wireless technology for digital cellular networks as defined by 3rd Generation Partnership Project (3GPP). Additionally, or alternatively, the aspects of this disclosure can be performed by a network and/or a UE that operates according to the Release 15 (Rel-15), Release 16 (Rel-16), Release 17 (Rel-17), Rel-17 new radio (NR), or others. However, the aspects of this disclosure are not limited to these examples, and one or more mechanisms of this disclosure can be implemented by other network(s) and/or UE(s) for implementing CSI reporting during SCell PUCCH activation.

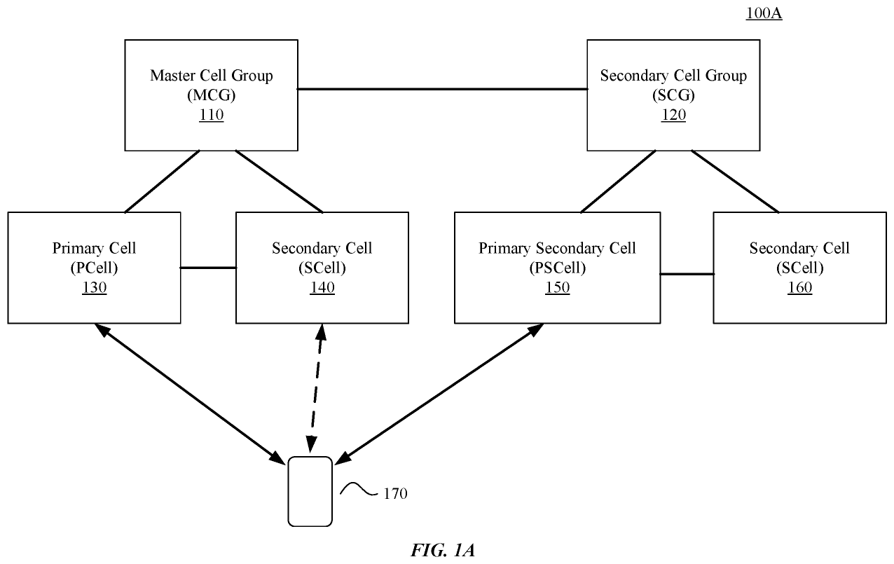

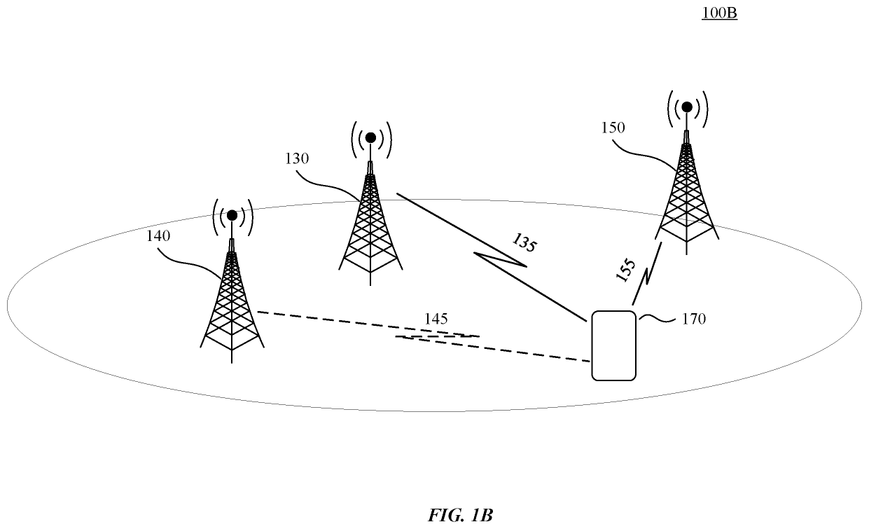

FIG. 1A illustrates an example system 100A implementing CSI reporting for SCell PUCCH activation, according to some aspects of the disclosure. Example system 100A is provided for the purpose of illustration only and does not limit the disclosed aspects.

System 100A depicts an example configuration of a UE 170 and network operating in dual-connectivity mode. Dual connectivity may provide a UE 170 with improved network coverage and/or data rates. This may be implemented using carrier aggregation. For example, multiple carriers may be combined to form a data channel to increase the capacity of the network. When providing dual connectivity, a master cell group (MCG) 110 may interface with a secondary cell group (SCG) 120. MCG 110 may include a primary cell (PCell) 130 and one or more secondary cells (SCell) 140. As further explained with reference to FIG. 1B, each cell (e.g., PCell 130 and/or SCell 140) may correspond to, or be represented by, a respective base station. MCG 110 may refer to the group of cells in which the UE 170 initiates random access to the communication network. For example, UE 170 may initiate access to the network with PCell 130. Within MCG 110, UE 170 may interface with SCell 140 to utilize carrier aggregated communications. As further discussed below, the UE 170 may execute an activation procedure to configure a physical uplink control channel (PUCCH) corresponding to SCell 140.

In some aspects, UE 170 may additionally communicate with primary secondary cell (PSCell) 150 corresponding to SCG 120. PSCell 150 may refer to a primary cell corresponding to SCG 120. Similar to PCell 130, PSCell 150 may be an initial access node for UE 170 to access SCG 120 and dual connectivity communications. UE 170 may also communicate with SCell 160 within SCG 120 through carrier aggregation as well. SCG 120 may include one or more SCells 160. SCell 160 may be similar to SCell 140. The discussion below will focus on the activation of the PUCCH corresponding to SCell 140

As further discussed below, the term “primary cell” may refer to PCell 130 and/or PSCell 150. In some aspects, UE 170 may communicate with a PUCCH corresponding to either PCell 130 and/or PSCell 150. A “primary cell” may also be referred to as an “spCell.” In some aspects, a “primary cell” may refer to a cell identified based on random access performed by UE 170. The term “secondary cell” may refer to SCell 140 and/or SCell 160. In some aspects, a “secondary cell” may refer to a second cell other than PCell 130 and/or PSCell 150 that performs carrier aggregation communications with UE 170. Once activated, one or more secondary cells may communicate with UE 170. In some aspects, a secondary cell may be rapidly activated or deactivated to address various communication traffic patterns. Some ambiguities exist during the activation process of an SCell or secondary cell, which are further addressed below.

FIG. 1B illustrates an example system 100B implementing CSI reporting for SCell PUCCH activation with base stations, according to some aspects of the disclosure. Example system 100B is provided for the purpose of illustration only and does not limit the disclosed aspects.

System 100B may include, but is not limited to, one or more network nodes (for example, a base station such as eNBs, gNBs, and the like) 130, 140, and 150 and an electronic device (for example, a UE) 170. Base stations 130, 140, 150 may correspond to, or represent, PCell 130, SCell 140, and PSCell 150 respectively as described with reference to FIG. 1A. The electronic device 170 (hereinafter referred to as UE 170) can be configured to operate based on a wide variety of wireless communication techniques. These techniques can include, but are not limited to, techniques based on 3rd Generation Partnership Project (3GPP) standards. For example, the UE 170 can be configured to operate using Rel-15, Rel-16, Rel-17 or other. The UE 170 can include, but is not limited to, wireless communication devices, smart phones, laptops, desktops, tablets, personal assistants, monitors, televisions, wearable devices, Internet of Things (IoTs), vehicle's communication devices, and the like. The network nodes 130, 140, 150 (herein referred to as a base station or a cell) can include one or more nodes configured to operate based on a wide variety of wireless communication techniques such as, but not limited to, techniques based on 3GPP standards. For example, base stations 130, 140, 150 can include one or more nodes configured to operate using Rel-15, Rel-16, Rel-17 or others.

According to some aspects, the UE 170 can be connected to and can communicate with the base stations 130, 140, and 150 using carriers 135, 145, and 155 respectively. According to some aspects, carriers 135, 145, and 155 may correspond to individual carriers. Additionally, or alternatively, carriers 135, 145, and 155 can include two or more component carriers (CC). In other words, the UE 170 can implement carrier aggregation (CA). For example, the UE 170 can use multiple carriers for communication with a primary cell (base stations 130 and/or 150) and a secondary cell (base station 140).

In some aspects, carriers 135, 145, and 155 may correspond to physical uplink control channel (PUCCH) communications between UE 170 and base stations 130, 140, 150 respectively. A PUCCH may carry uplink control information from UE 170 to a particular base station or cell. For example, UE 170 may establish a PUCCH with PCell or base station 130. UE 170 may also establish another PUCCH with PSCell or base station 150. To provide carrier aggregation, UE 170 may also perform an activation process to activate a PUCCH corresponding to SCell or base station 140. In some aspects, UE 170 may initially communicate with base stations 130, 150 (PCell 130 and/or PSCell 150) and then activate a PUCCH corresponding to base station 140 (SCell 140).

When activating a PUCCH corresponding to a base station 130, 140, 150, UE 170 may report channel state information (CSI). The CSI may refer to the quality of a particular channel between a base station 130, 140, 150 and UE 170. CSI may include one or more measurements performed by UE 170 and reported to a base station 130, 140, 150.

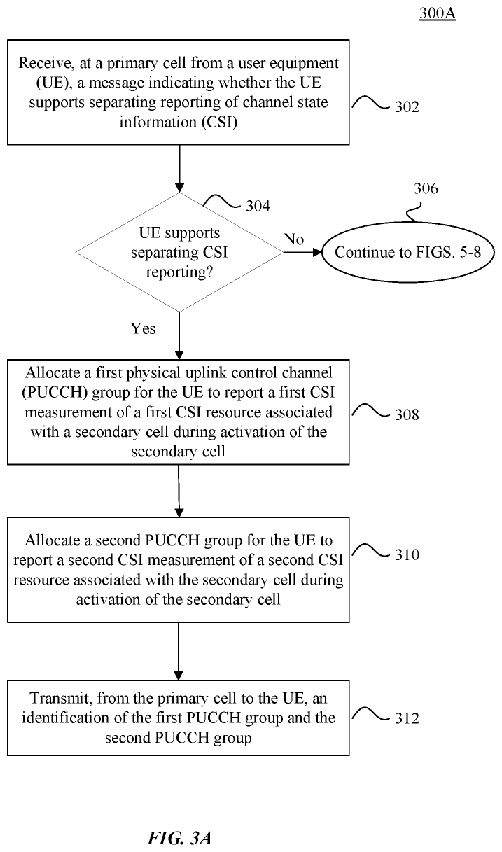

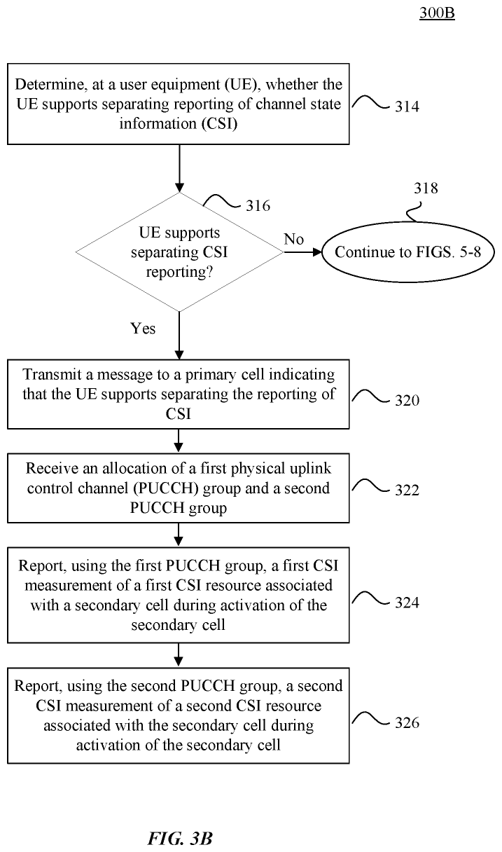

Some CSI measurements include layer-1, reference signal received power (L1-RSRP), channel quality indicator (CQI), rank indicator (RI), precoding matrix indicator (PMI), CSI-RS resource indicator (CRI), SS/PBCH resource block indicator (SSBRI), Layer Indicator (LI), and/or other CSI measurements. While the following discussion focuses on L1-RSRP and CQI, this disclosure is also applicable to reporting these other CSI measurements as well. Additionally, the discussion of these parameters below generally refers to a network connecting base station 130, 140, 150 and the processing of this reporting. FIGS. 3-8 further describe CSI reporting for SCell 140 or secondary cell activation.

L1-RSRP may be a beam measurement conducted by UE 170. For example, a network (via a base station) may transmit reference signal resources corresponding to different transmission beams for detection by UE 170. UE 170 may measure an L1-RSRP for each of these transmission beams. For example, the network may transmit eight different reference signals and/or instruct UE 170 to perform eight L1-RSRP measurements. The UE 170 may then report the result of the measurement to the network via a base station. Using the L1-RSRP measurements, the network may identify the beam or reference signal having the strongest received signal at UE 170 and use the identified beam for data communications. That is, the network may associate transmission beams carrying UE data with the corresponding identified reference signal. The network may use the reported L1-RSRP measurement from UE 170 to determine a transmission configuration indicator (TCI) for UE 170. The TCI indicates the particular beam used to transmit data to UE 170.

CQI may be an indicator of channel quality. It may be expressed as an index value. In some aspects, the CQI may also be a null or out of range (OOR) value. The CQI may correspond to a handshake mechanism between the network and UE 170. The CQI may inform the network of whether UE 170 has completed activation for a particular PUCCH. For example, UE 170 may receive an activation command and then report a CQI to the network. In some aspects, this reporting may be periodic. During activation of a particular PUCCH, however, UE 170 has not completed activation and therefore may report an OOR value for the CQI. UE 170 may continue to report an OOR value until UE 170 completes activation of the PUCCH. For example, as further describes below, this may apply to the activation of a PUCCH for SCell 140. After activating the PUCCH, UE 170 may report a valid CQI value. A valid CQI may be an index value different from the OOR value. The reporting of this valid CQI notifies the network that UE 170 has completed activation of the PUCCH. The network may then proceed with communications with UE 170. For example, UE 170 may periodically report an OOR value during activation of SCell 140. Upon completion of activation, UE 170 may report a valid CQI to the network to indicate that SCell 140 has been activated and that UE 170 is ready for communications with SCell 140.

While the L1-RSRP measurement and CQI have been described with reference to a network connecting base stations 130, 140, and 150, the disclosure will further address the particular communication pathways used for CSI reporting during activation of a PUCCH for SCell 140. There are some ambiguities that arise during the activation of a PUCCH for SCell 140. For example, SCell 140 may provide reference signals for measurement, but if uplink communications have not been established for UE 170 to use the PUCCH corresponding to SCell 140, it may be unclear where UE 170 should report its CSI measurement results. The PUCCH corresponding to SCell 140 may not be ready for usage. In this case, UE 170 may perform L1-RSRP and CQI measurement and reporting related to SCell 140 (i.e., the same target cell) but may not necessarily report these measurements back to SCell 140 during its PUCCH activation.

To address this ambiguity, the processes described below address separating reporting of CSI information between multiple PUCCH groups. For example, UE 170 may report CSI measurements including L1-RSRP and/or CQI measurements using a PUCCH corresponding to PCell 130, PSCell 150, and/or SCell 140. In this manner, UE 170 may perform CSI measurements related to SCell 140 but may then report these measurements using different PUCCH groups corresponding to different cells than that of SCell 140. That is, for a particular cell's CSI reporting, the processes below outline a way for UE 170 to report measurements using different cells. Additionally, the processes account for situations where UE 170 may not have the capability to perform such separation of CSI reporting. In this manner, a network may facilitate communications with UEs 170 that are capable as well as UEs 170 that are not capable of separating CSI reporting for a particular cell (e.g., SCell 140) using different PUCCH groups.

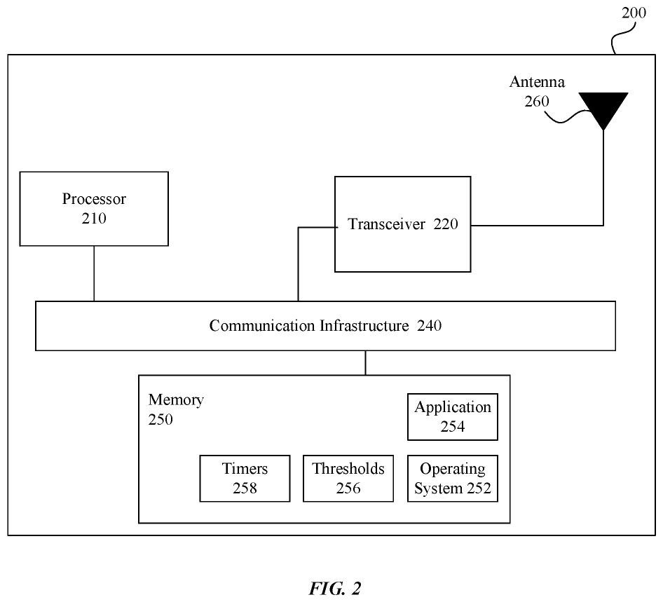

FIG. 2 illustrates a block diagram of an example system 200 of an electronic device implementing CSI reporting for SCell PUCCH activation, according to some aspects of the disclosure. System 200 may be any of the electronic devices (e.g., base stations 130, 140, 150, and/or UE 170) of systems 100A, 100B. System 200 includes a processor 210, one or more transceivers 220, a communication infrastructure 240, a memory 250, operating system 252, application 254, thresholds 256, timers 258, and/or an antenna 260. Illustrated systems are provided as exemplary parts of system 200, and system 200 can include other circuit(s) and subsystem(s). Also, although the systems of system 200 are illustrated as separate components, the aspects of this disclosure can include any combination of these, less, or more components. Also, system 200 of the aspects of this disclosure can include any number of processors, transceivers, communication infrastructures, memories, operating systems, applications, and antennas.

The memory 250 may include random access memory (RAM) and/or cache, and may include control logic (e.g., computer software) and/or data. The memory 250 may include other storage devices or memory such as, but not limited to, a hard disk drive and/or a removable storage device/unit. According to some examples, the operating system 252 can be stored in memory 250. The operating system 252 can manage transfer of data between the memory 250, one or more applications 254, the processor 210, and/or one or more transceivers 220. In some examples, the operating system 252 maintains one or more network protocol stacks (e.g., Internet protocol stack, cellular protocol stack, and the like) that can include a number of logical layers. At corresponding layers of the protocol stack, the operating system 252 includes control mechanism and data structures to perform the functions associated with that layer.

According to some examples, the application 254 can be stored in the memory 250. The application 254 can include applications (e.g., user applications) used by wireless system 200 and/or a user of wireless system 200. The applications in the application 254 can include applications such as, but not limited to, radio streaming, video streaming, remote control, and/or other user applications.

According to some aspects, the memory 250 can store different thresholds 256. The thresholds 256 can include, but are not limited to, the BLER threshold, the retransmission threshold, SINR threshold, HARQ threshold, DL channel quality threshold, UL channel quality threshold, or the like. The memory 250 can store timers 258. The timers 256 can include timers and/or counters discussed herein. However, the aspects of this disclosure are not limited to these examples and the memory 250 can include other thresholds, timers, and/or counters.

System 200 can also include the communication infrastructure 240. The communication infrastructure 240 provides communication between, for example, the processor 210, the one or more transceivers 220, and the memory 250. In some implementations, the communication infrastructure 240 may be a bus. The processor 210 together with instructions stored in memory 250 performs operations enabling system 200 to implement CSI reporting for SCell PUCCH activation, as described herein. Alternatively, the processor can be “hard-coded” to perform operations enabling system 200 to implement CSI reporting for SCell PUCCH activation, as described herein.

The one or more transceivers 220 transmit and receive communications signals that support the operations of system 200 including, but not limited to, CSI reporting for SCell PUCCH activation, according to some aspects, and may be coupled to the antenna 260. The antenna 260 may include one or more antennas that may be the same or different types. The one or more transceivers 220 allow system 200 to communicate with other devices that may be wired and/or wireless. In some examples, the one or more transceivers 220 can include processors, controllers, radios, sockets, plugs, buffers, and like circuits/devices used for connecting to and communication on networks. According to some examples, the one or more transceivers 220 include one or more circuits to connect to and communicate on wired and/or wireless networks.

According to some aspects, the one or more transceivers 220 can include a cellular subsystem, a WLAN subsystem, and/or a Bluetooth™ subsystem, each including its own radio transceiver and protocol(s) as will be understood by those skilled arts based on the discussion provided herein. In some implementations, the one or more transceivers 220 can include more or fewer systems for communicating with other devices.

In some examples, the one or more transceivers 220 can include one or more circuits (including a WLAN transceiver) to enable connection(s) and communication over WLAN networks such as, but not limited to, networks based on standards described in IEEE 802.11. Additionally, or alternatively, the one or more transceivers 220 can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 220n can include a Bluetooth™ transceiver.

Additionally, the one or more transceivers 220 can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like. For example, the one or more transceivers 220a-220n can be configured to operate according to one or more of Rel-15, Rel-16, Rel-17, or other of the 3GPP standards.

According to some aspects, the processor 210, alone or in combination with computer instructions stored within the memory 250, and/or the one or more transceiver 220, implements CSI reporting for SCell PUCCH activation, as discussed herein.

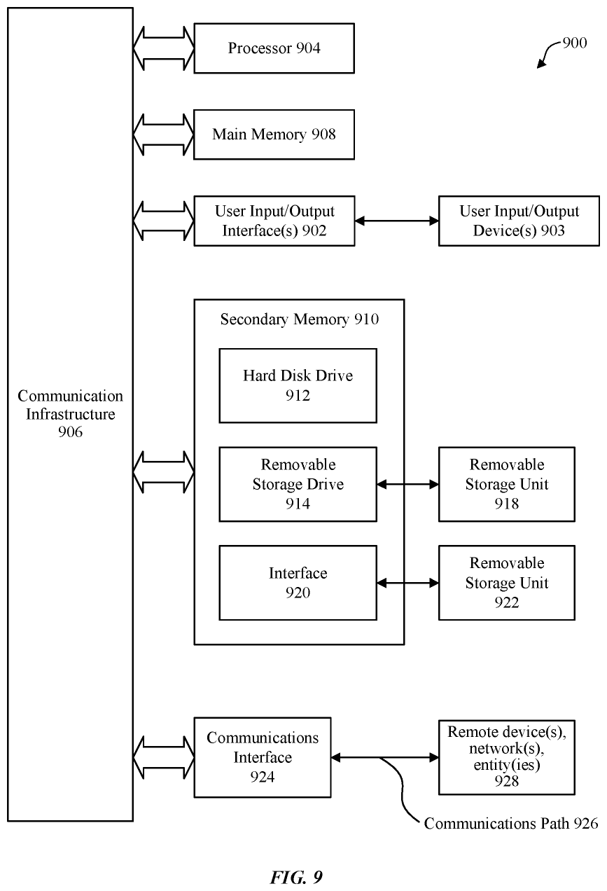

FIG. 3A illustrates an example method for a system (for example, a base station) allocating two PUCCH groups for a UE to report CSI measurements corresponding to an SCell, according to some aspects of the disclosure. As a convenience and not a limitation, FIG. 3A may be described with regard to elements of FIGS. 1A-1B. Method 300A may represent the operation of a base station (for example, PCell 130 or PSCell 150 of FIG. 1A or corresponding base stations 130 or 150 of FIG. 1B) implementing CSI reporting for PUCCH activation for SCell 140. As previously explained, the term “primary cell” may refer to PCell 130 or PSCell 150. The term “secondary cell” may refer to SCell 140. Method 300A may also be performed by system 200 of FIG. 2 and/or computer system 900 of FIG. 9. But method 300A is not limited to the specific aspects depicted in those figures and other systems may be used to perform the method as will be understood by those skilled in the art. It is to be appreciated that not all operations may be needed, and the operations may not be performed in the same order as shown in FIG. 3A.

At 302, a primary cell may receive, from a UE 170, a message indicating whether the UE 170 supports separating reporting of channel state information (CSI). As previously explained, the primary cell may be PCell 130 or PSCell 150. UE 170 may have established communications with the primary cell. For example, UE 170 may be configured to provide CSI information using a PUCCH group corresponding to the primary cell. In some aspects, UE 170 may provide an indication of whether it supports the capability of separating CSI reporting onto multiple PUCCH groups. For example, this may refer to using two or more PUCCH groups corresponding to different cells. UE 170 may transmit a message to the primary cell indicating that it is capable of separating CSI reporting for a particular cell using multiple cells. This message may indicate capability of separating CSI reporting for reference signals provided by a secondary cell.

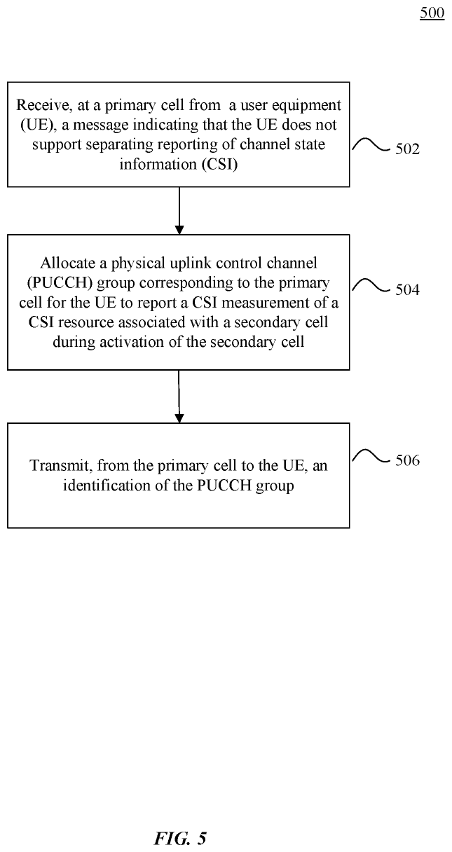

At 304, the primary cell may determine whether UE 170 supports separating CSI reporting. For example, the primary cell may perform this determination based on the message received from UE 170. If UE 170 has signaled that it does not support this capability, at 306, the primary cell may interface UE 170 via the one or more processes described with reference to FIGS. 5-8. The methods described with reference to FIGS. 5-8 provide instructions to UE 170 that are not capable of separating CSI reporting. If UE 170 has indicated that it supports the capability of separating CSI reporting, the primary cell moves to 308. The indication that UE 170 supports separation of CSI reporting indicates that the primary cell may allocate two different PUCCH groups for the reporting of measurements corresponding to a particular cell such as the secondary cell.

At 308, the primary cell may allocate a first PUCCH group for UE 170 to report a first CSI measurement of a first CSI resource associated with a secondary cell during activation of the secondary cell. At 310, the primary cell may allocate a second PUCCH group for UE 170 to report a second CSI measurement of a second CSI resource associated with the secondary cell during activation of the secondary cell.

For example, when performing the allocation, the first PUCCH group may correspond to the primary cell while the second PUCCH group may correspond to the secondary cell. UE 170 may perform CSI measurements based on CSI resources or reference signals transmitted by the secondary cell. That is, UE 170 may perform one or more CSI measurements associated with the secondary cell. These measurements may occur during activation of the secondary cell. Based on the signaling of UE 170 having the capability to separate the reporting of these CSI measurements, UE 170 may report the CSI measurements associated with the secondary cell using the first PUCCH group and the second PUCCH group. In some aspects, this may correspond to UE 170 transmitting a first CSI measurement to the primary cell (using the primary cell's PUCCH) and transmitting a second CSI measurement to the secondary cell (using the secondary cell's PUCCH).

In some aspects, UE 170 may report an L1-RSRP measurement and a CQI both associated with the secondary cell. For example, the L1-RSRP measurement may correspond to the first CSI measurement and the CQI reporting may correspond to the second CSI measurement. Both may correspond to CSI resources from the being-activated secondary cell, where “being-activated” refers to a secondary cell that is in the process of being activated for UE communication. During activation of the PUCCH for the secondary cell, the primary cell may assign the L1-RSRP reporting to a first PUCCH group corresponding to the primary cell. The primary cell may also assign CQI reporting to a second PUCCH group corresponding to the secondary cell. The primary cell or network may perform this allocation based on UE 170 being able to support the separate PUCCH reporting for a particular cell (e.g., the secondary cell). While L1-RSRP and CQI are discussed here, the separation of CSI reporting may also apply to other CSI measurements as previously discussed.

For example, UE 170 may report an L1-RSRP measurement and a CQI associated with SCell 140. Both may correspond to CSI resources to the being-activated SCell 140. During activation of the PUCCH for SCell 140, PCell 130 may assign the L1-RSRP reporting to a first PUCCH group corresponding to PCell 130. PCell 130 may also assign CQI reporting to a second PUCCH group corresponding to SCell 140. PCell 130 may perform this allocation based on UE 170 being able to support separate CSI reporting for SCell 140.

At 312, the primary cell may transmit an identification of the first PUCCH group and the second PUCCH group to UE 170. This informs UE 170 of the allocations and also where to transmit its CSI measurements.

FIG. 3B illustrates an example method for a system (for example, a UE) reporting CSI measurements corresponding to an SCell using two PUCCH groups, according to some aspects of the disclosure. As a convenience and not a limitation, FIG. 3B may be described with regard to elements of FIGS. 1A-1B. Method 300B may represent the operation of a UE (for example, UE 170 of FIG. 1A or FIG. 1B) implementing CSI reporting for PUCCH activation for SCell 140. As previously explained, the term “primary cell” may refer to PCell 130 or PSCell 150. The term “secondary cell” may refer to SCell 140. Method 300B may also be performed by system 200 of FIG. 2 and/or computer system 900 of FIG. 9. But method 300B is not limited to the specific aspects depicted in those figures and other systems may be used to perform the method as will be understood by those skilled in the art. It is to be appreciated that not all operations may be needed, and the operations may not be performed in the same order as shown in FIG. 3B.

Method 300B may correspond to a UE operation that complements the operation described in method 300A with reference to FIG. 3A. The description of UE operation provided for method 300A is also applicable to method 300B.

At 314 and 316, UE 170 may determine whether UE 170 supports separating reporting of CSI. If UE 170 does not support this capability, at 318, the UE 170 may interface with a primary cell as described with reference to FIGS. 5-8. If UE 170 determines that it supports separating CSI reporting, at 320, UE 170 transmits a message to a primary cell indicating that the UE supports separating the reporting of CSI. At 322, UE 170 may receive an allocation of a first PUCCH group and a second PUCCH group. At 324, UE 170 may report, using the first PUCCH group, a first CSI measurement of a first CSI resource associated with a secondary cell during activation of the secondary cell. At 326, UE 170 may report, using the second PUCCH group, a second CSI measurement of a second CSI resource associated with the secondary cell during activation of the secondary cell.

As previously explained, the first PUCCH group may correspond to the primary cell. UE 170 may report an L1-RSRP measurement using the first PUCCH group. The second PUCCH group may correspond to the secondary cell. UE 170 may report a CQI measurement using the second PUCCH group.

For example, UE 170 may report an L1-RSRP measurement and a CQI associated with SCell 140. Both may correspond to CSI resources to the being-activated SCell 140. During activation of the PUCCH for SCell 140, UE 170 may report the L1-RSRP measurement via a first PUCCH group corresponding to PCell 130. UE 170 may report the CQI via a second PUCCH group corresponding to SCell 140. This may occur when UE 170 has the capability to support separate CSI reporting for SCell 140.

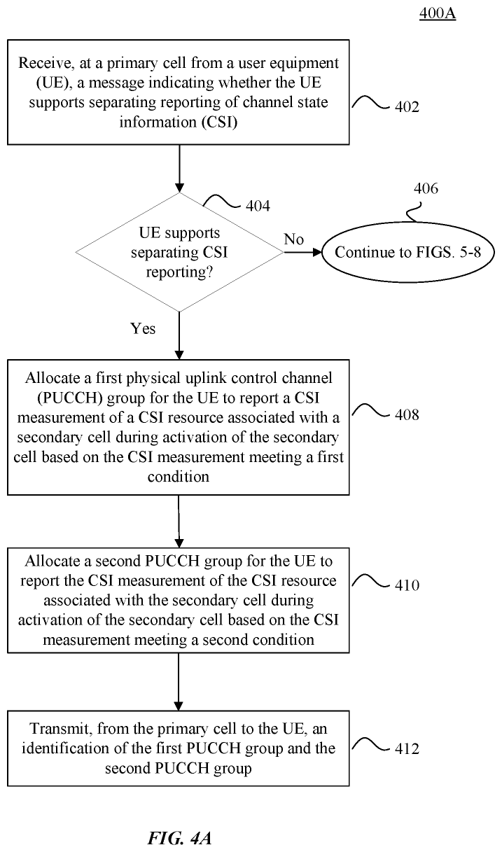

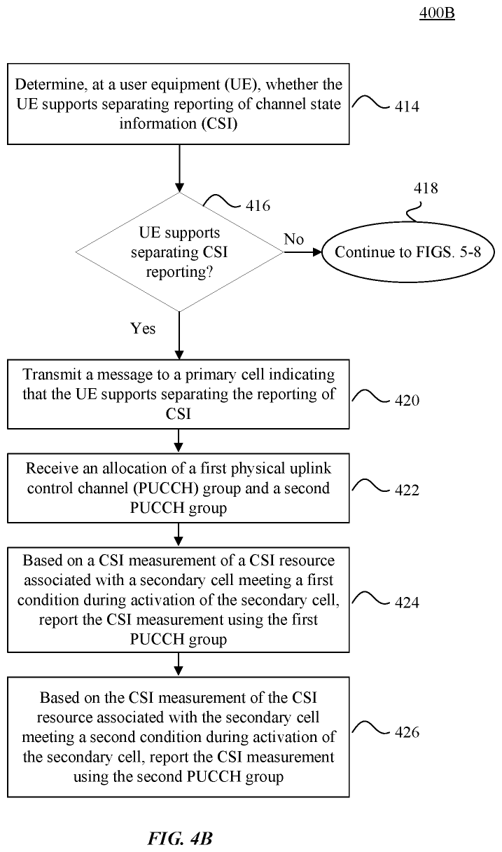

FIG. 4A illustrates an example method for a system (for example, a base station) allocating two PUCCH groups for a UE to report CSI measurements corresponding to an SCell based on one or more conditions, according to some aspects of the disclosure. As a convenience and not a limitation, FIG. 4A may be described with regard to elements of FIGS. 1A-1B. Method 400A may represent the operation of a base station (for example, PCell 130 or PSCell 150 of FIG. 1A or base stations 130 or 150 of FIG. 1B) implementing CSI reporting for PUCCH activation for SCell 140. As previously explained, the term “primary cell” may refer to PCell 130 or PSCell 150. The term “secondary cell” may refer to SCell 140. Method 400A may also be performed by system 200 of FIG. 2 and/or computer system 900 of FIG. 9. But method 400A is not limited to the specific aspects depicted in those figures and other systems may be used to perform the method as will be understood by those skilled in the art. It is to be appreciated that not all operations may be needed, and the operations may not be performed in the same order as shown in FIG. 4A.

At 402, a primary cell may receive, from a UE 170, a message indicating whether the UE 170 supports separating reporting of channel state information (CSI). As previously explained, the primary cell may be PCell 130 or PSCell 150. UE 170 may have established communications with the primary cell. For example, UE 170 may be configured to provide CSI information using a PUCCH group corresponding to the primary cell. In some aspects, UE 170 may provide an indication of whether it supports the capability of separating CSI reporting onto multiple PUCCH groups. For example, this may refer to using two or more PUCCH groups corresponding to different cells. UE 170 may transmit a message to the primary cell indicating that it is capable of separating CSI reporting for a particular cell using multiple cells. This message may indicate capability of separating CSI reporting for reference signals provided by a secondary cell.

At 404, the primary cell may determine whether UE 170 supports separating CSI reporting. For example, the primary cell may perform this determination based on the message received from UE 170. If UE 170 has signaled that it does not support this capability, at 406, the primary cell may interface with UE 170 via the one or more processes described with reference to FIGS. 5-8. The methods described with reference to FIGS. 5-8 provide instructions to UE 170 that are not capable of separating CSI reporting. If UE 170 has indicated that it supports the capability of separating CSI reporting, the primary cell moves to 408. The indication that UE 170 supports separation of CSI reporting indicates that the primary cell may allocate two different PUCCH groups for the reporting of measurements corresponding to a particular cell such as the secondary cell.

At 408, the primary cell may allocate a first PUCCH group for UE 170 to report a CSI measurement of a CSI resource associated with a secondary cell during activation of the secondary cell based on the CSI measurement meeting a first condition. At 410, the primary cell may allocate a second PUCCH group for UE 170 to report the CSI measurement of the CSI resource associated with the secondary cell during activation of the secondary cell based on the CSI measurement meeting a second condition. At 412, the primary cell may transmit an identification of the first PUCCH group and the second PUCCH group to UE 170. This informs UE 170 of the allocations and also where to transmit its CSI measurements.

As seen from this operation, method 400A focuses on a particular CSI resource or reference signal. Method 400A describes determining a particular PUCCH group to use to report the measurement for the particular CSI resource. This differs from method 300A described with reference to FIG. 3A. Method 300A focused on the scenario where there are two different CSI resources or two different CSI reference signals corresponding to the secondary cell. In method 300A, UE 170 may report a first measurement corresponding to the first reference signal using a first PUCCH group. UE 170 may report a second measurement corresponding to the second reference signal using a second PUCCH group.

In contrast, method 400A focuses on allocating multiple PUCCH groups for a particular CSI resource. For example, this may be a single resource or reference signal corresponding to the secondary cell. Method 400A describes determining which PUCCH group to use based on one or more conditions. For example, a CSI measurement for reporting may be a CQI. In some aspects, the condition may be the particular value for the CQI. For example, a first condition may be that the CQI value is out of range (OOR) while a second condition may be that the CQI value is a valid value or a non-OOR value. In some aspects, the first and second conditions may be considered as a single condition, determination, and/or decision. For the CQI reporting, the primary cell may allocate PUCCH groups depending on the value for the CQI. For example, when UE 170 is reporting an OOR CQI, UE 170 may report the CQI reporting using the first PUCCH group. In some aspects, the first PUCCH group may correspond to the primary cell. When UE 170 is reporting a valid or non-OOR CQI, UE 170 may report the CQI reporting using the second PUCCH group. In some aspects, the second PUCCH group may correspond to the secondary cell. In this case, when UE 170 is still in the process of completing activation of the secondary cell and reporting an OOR value, UE 170 may use the first PUCCH group. If UE 170 has completed activation of the secondary cell, UE 170 may report the valid CQI via the second PUCCH group. In this manner, the reporting of the measurement result may be based on one or more conditions.

For example, UE 170 may report a CQI measurement using a first PUCCH group corresponding to PCell 130 or using a second PUCCH group corresponding to SCell 140. When UE 170 is reporting an OOR CQI, UE 170 may report the CQI using the first PUCCH group corresponding to PCell 130. When UE 170 is reporting a valid or non-OOR CQI, UE 170 may report the CQI using the second PUCCH group corresponding to SCell 140.

In some aspects, UE 170 may also report the L1-RSRP measurement based on a condition. For example, UE 170 may use the first PUCCH group to report the L1-RSRP measurement when it corresponds to the lowest L1-RSRP index. UE 170 may use the second PUCCH group when the L1-RSRP measurement is an index value other than the lowest index.

In some aspects, UE 170 may report multiple CSI measurements. One or more CSI measurements may be assigned to a particular PUCCH group while others may be assigned based on a condition. For example, the primary cell may allocate L1-RSRP reporting for the secondary cell using a first PUCCH group corresponding to the primary cell. While UE 170 may be assigned to report L1-RSRP using the first PUCCH group, UE 170 may apply the condition for the CQI as previously discussed. For example, when CQI is OOR, UE 170 may use the first PUCCH group. When the CQI is valid or non-OOR, UE 170 may report the CQi using the second PUCCH group. In this manner, UE 170 may perform both an assigned CSI reporting as well as a CSI reporting based on a condition.

When reporting using the first and second PUCCH groups, the UE 170 may report the result in a time-division multiplexed (TDM) configuration in some aspects. For example, UE 170 may use a first measurement period to report a CSI measurement using the first PUCCH group. UE 170 then uses a second measurement period to report a CSI measurement using the second PUCCH group.

FIG. 4B illustrates an example method for a system (for example, a UE) reporting CSI measurements corresponding to an SCell using two PUCCH groups based on one or more conditions, according to some aspects of the disclosure. As a convenience and not a limitation, FIG. 4B may be described with regard to elements of FIGS. 1A-1B. Method 400B may represent the operation of a UE (for example, UE 170 of FIG. 1A or FIG. 1B) implementing CSI reporting for PUCCH activation for SCell 140. As previously explained, the term “primary cell” may refer to PCell 130 or PSCell 150. The term “secondary cell” may refer to SCell 140. Method 400B may also be performed by system 200 of FIG. 2 and/or computer system 900 of FIG. 9. But method 400B is not limited to the specific aspects depicted in those figures and other systems may be used to perform the method as will be understood by those skilled in the art. It is to be appreciated that not all operations may be needed, and the operations may not be performed in the same order as shown in FIG. 4B.

Method 400B may correspond to a UE operation that complements the operation described in method 400A with reference to FIG. 4A. The description of UE operation provided for method 400A is also applicable to method 400B.

At 414 and 416, UE 170 may determine whether UE 170 supports separating reporting of CSI. If UE 170 does not support this capability, at 418, the UE 170 may interface with a primary cell as described with reference to FIGS. 5-8. If UE 170 determines that it supports separating CSI reporting, at 420, UE 170 transmits a message to a primary cell indicating that the UE supports separating the reporting of CSI.

At 422, UE 170 may receive an allocation of a first PUCCH group and a second PUCCH group. At 424, based on a CSI measurement of a CSI resource associated with a secondary cell meeting a first condition during activation of the secondary cell, UE 170 may report the CSI measurement using the first PUCCH group. At 426, based on the CSI measurement meeting a second condition during activation of the secondary cell, UE 170 may report the CSI measurement of the CSI resource associated with the secondary cell using the second PUCCH group.

As previously explained, the first PUCCH group may correspond to the primary cell. The CSI measurement may correspond to a CQI value. The first condition may be when the CQI is an OOR value. When the CQI is an OOR value, UE 170 may report the OOR result using the first PUCCH group corresponding to the primary cell. In some aspects, the second PUCCH group may correspond to the secondary cell. The second condition may be when the CQI is a valid or non-OOR value. When the CQI is a valid or non-OOR value, UE 170 may report the OOR result using the second PUCCH group corresponding to the secondary cell. While CQI may be an example CSI measurement, this process may also apply to other CSI measurements as previously discussed.

FIG. 5 illustrates an example method for a system (for example, a base station) allocating a PCell PUCCH group for a UE to report CSI measurements when the UE is not capable of CSI report separation, according to some aspects of the disclosure. As a convenience and not a limitation, FIG. 5 may be described with regard to elements of FIGS. 1A-1B. Method 500 may represent the operation of a base station (for example, PCell 130 or PSCell 150 of FIG. 1A or base stations 130 or 150 of FIG. 1B) implementing CSI reporting for PUCCH activation for SCell 140. As previously explained, the term “primary cell” may refer to PCell 130 or PSCell 150. The term “secondary cell” may refer to SCell 140. Method 500 may also be performed by system 200 of FIG. 2 and/or computer system 900 of FIG. 9. But method 500 is not limited to the specific aspects depicted in those figures and other systems may be used to perform the method as will be understood by those skilled in the art. It is to be appreciated that not all operations may be needed, and the operations may not be performed in the same order as shown in FIG. 5.

At 502, a primary cell may receive, from a UE 170, a message indicating that UE 170 does not support separating reporting of channel state information (CSI). This may correspond to 306 or 406 as described with reference to FIG. 3A and FIG. 4A respectively.

At 504, the primary cell may allocate a PUCCH group corresponding to the primary cell for UE 170 to report a CSI measurement of a CSI resource associated with a secondary cell during activation of the secondary cell. In this case, the primary cell may direct UE 170 to report its CSI measurements associated with the secondary cell using a PUCCH group corresponding to the primary cell. For example, the network or primary cell may impose a restriction on the reporting performed by UE 170. UE 170 may report L1-RSRP and CQI measurements using the PUCCH group corresponding to the primary cell. This may occur because UE 170 does not support separate CSI reporting using different PUCCH groups during activation of the secondary cell. In some aspects, after the secondary cell has been activated, the network, via the primary cell and/or the secondary cell, may reconfigure UE 170 to perform CSI reporting using either a PUCCH corresponding to the primary cell and/or a PUCCH corresponding to the secondary cell.

At 506, the primary cell may transmit an identification of the PUCCH group to UE 170. This informs UE 170 of the allocation and identifies the PUCCH group for CSI reporting during activation of the secondary cell.

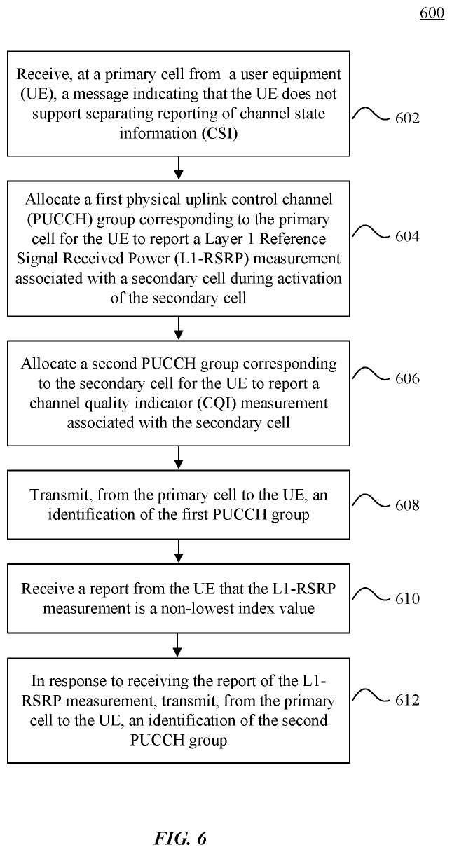

FIG. 6 illustrates an example method for a system (for example, a base station) allocating two PUCCH groups for a UE to report CSI measurements based on the type of CSI measurement when the UE is not capable of report separation, according to some aspects of the disclosure. As a convenience and not a limitation, FIG. 6 may be described with regard to elements of FIGS. 1A-1B. Method 600 may represent the operation of a base station (for example, PCell 130 or PSCell 150 of FIG. 1A or base stations 130 or 150 of FIG. 1B) implementing CSI reporting for PUCCH activation for SCell 140. As previously explained, the term “primary cell” may refer to PCell 130 or PSCell 150. The term “secondary cell” may refer to SCell 140. Method 600 may also be performed by system 200 of FIG. 2 and/or computer system 900 of FIG. 9. But method 600 is not limited to the specific aspects depicted in those figures and other systems may be used to perform the method as will be understood by those skilled in the art. It is to be appreciated that not all operations may be needed, and the operations may not be performed in the same order as shown in FIG. 6.

At 602, a primary cell may receive, from a UE 170, a message indicating that UE 170 does not support separating reporting of channel state information (CSI). This may correspond to 306 or 406 as described with reference to FIG. 3A and FIG. 4A respectively.

At 604, the primary cell may allocate a first PUCCH group corresponding to the primary cell for UE 170 to report a L1-RSRP measurement associated with a secondary cell during activation of the secondary cell. At 606, the primary cell may allocate a second PUCCH group associated with the secondary cell for UE 170 to report a CQI measurement associated with the secondary cell. With this allocation, the primary cell or network may set up a reconfiguration for UE 170 after it has received a L1-RSRP measurement. UE 170 may transmit the L1-RSRP measurement using the first PUCCH group corresponding to the primary cell. After the primary cell receives the L1-RSRP measurement, the primary cell reconfigures UE 170 to provide a CQI measurement using the PUCCH corresponding to the secondary cell.

At 608, the primary cell may transmit an identification of the first PUCCH group to UE 170. In some aspects, the primary cell may inform UE 170 to use the first PUCCH group to perform the L1-RSRP reporting. The network or primary cell may then wait for UE 170 to perform the L1-RSRP reporting and measurement. In some aspects, the primary cell may wait for UE 170 to report a non-lowest index value for the L1-RSRP. which indicates that UE 170 has completed the measurement. As previously discussed, this may indicate that UE 170 has determined the best beam for communications with the secondary cell. This may be a beam from the secondary cell with the strongest received signal at UE 170. UE 170 may report the L1-RSRP measurement to the primary cell. In some aspects, UE 170 may report the L1-RSRP measurement prior to completion of the secondary cell activation process.

At 610, the primary cell may receive a report from UE 170 that the L1-RSRP measurement is a non-lowest index value. For example, UE 170 may report one or more L1-RSRP measurements associated with transmission beams from the secondary cell. UE 170, the primary cell, and/or the network may determine the particular transmission beam to use for the secondary cell to communicate with UE 170 using the L1-RSRP measurements. The non-lowest index value may be an indication from UE 170 of the beam with the strongest received signal among a number of reference signals transmitted by the secondary cell.

At 612, in response to receiving the report of the L1-RSRP measurement, the primary cell may transmit an identification of the second PUCCH group to the UE 170. This may reconfigure UE 170 to report the CQI using the PUCCH group corresponding to the secondary cell. In some aspects, UE 170 may periodically report an OOR CQI value until UE 170 has completed the activation process for the secondary group. UE 170 may then report a valid or non-OOR CQI value to the secondary cell using the second PUCCH group when activation has completed.

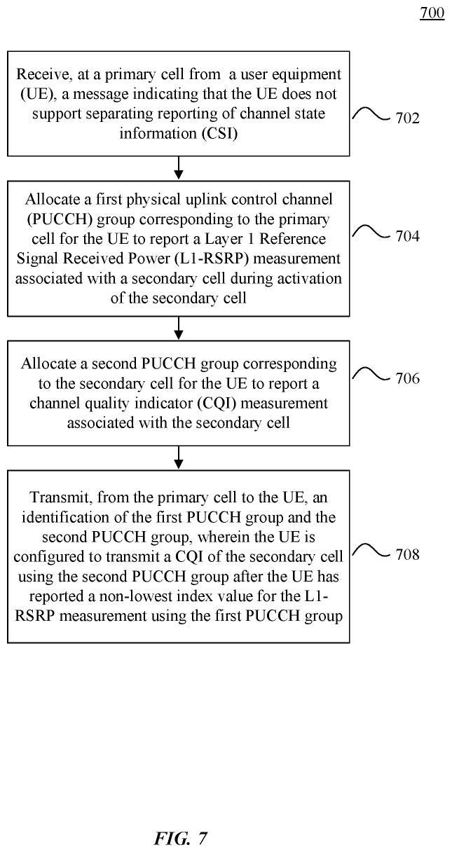

FIG. 7 illustrates an example method for a system (for example, a base station) allocating two PUCCH groups and preconfiguring a UE to report CSI measurements based on the type of CSI measurement when the UE is not capable of report separation, according to some aspects of the disclosure. As a convenience and not a limitation, FIG. 7 may be described with regard to elements of FIGS. 1A-1B. Method 700 may represent the operation of a base station (for example, PCell 130 or PSCell 150 of FIG. 1A or base stations 130 or 150 of FIG. 1B) implementing CSI reporting for PUCCH activation for SCell 140. As previously explained, the term “primary cell” may refer to PCell 130 or PSCell 150. The term “secondary cell” may refer to SCell 140. Method 700 may also be performed by system 200 of FIG. 2 and/or computer system 900 of FIG. 9. But method 700 is not limited to the specific aspects depicted in those figures and other systems may be used to perform the method as will be understood by those skilled in the art. It is to be appreciated that not all operations may be needed, and the operations may not be performed in the same order as shown in FIG. 7.

At 702, a primary cell may receive, from a UE 170, a message indicating that UE 170 does not support separating reporting of channel state information (CSI). This may correspond to 306 or 406 as described with reference to FIG. 3A and FIG. 4A respectively.

At 704, the primary cell may allocate a first PUCCH group corresponding to the primary cell for UE 170 to report a L1-RSRP measurement associated with a secondary cell during activation of the secondary cell. At 706, the primary cell may allocate a second PUCCH group corresponding to the secondary cell for UE 170 to report a CQI measurement associated with the secondary cell. At 708, the primary cell may transmit to UE 170 an identification of the first PUCCH group and the second PUCCH group, wherein the UE is configured to transmit a CQI of the secondary cell using the second PUCCH group after the UE has reported a non-lowest index value for the L1-RSRP measurement using the first PUCCH group. In some aspects, the primary cell may transmit a message instructing UE 170 to perform this reporting. In some aspects, UE 170 may implement a switching rule and may autonomously switch from the first PUCCH to the second PUCCH group. For example, this switching rule may be executed by UE 170 without an instruction from the primary cell.

With this allocation, the primary cell or network may pre-configure UE 170 to use the first PUCCH group for L1-RSRP reporting and the second PUCCH group for CQI reporting. In this manner, after UE 170 has reported a non-lowest index value for the L1-RSRP measurement, UE 170 may automatically switch to reporting CQI using the second PUCCH group corresponding to the secondary cell that is being activated. In some aspects, UE 170 may apply a TDM configuration when communicating using the first and second PUCCH groups. For example, UE 170 may use the first PUCCH group during a first period to report the L1-RSRP measurement. Then, after UE 170 has completed and reported the L1-RSRP measurement, UE 170 may automatically reconfigures its CSI reporting to report the CQI measurement using the second PUCCH group. As previously explained, the second PUCCH group may correspond to the secondary cell. In some aspects, the primary cell messaging and instructions may be considered a preconfiguration of UE 170 to change PUCCH group usage via TDM.

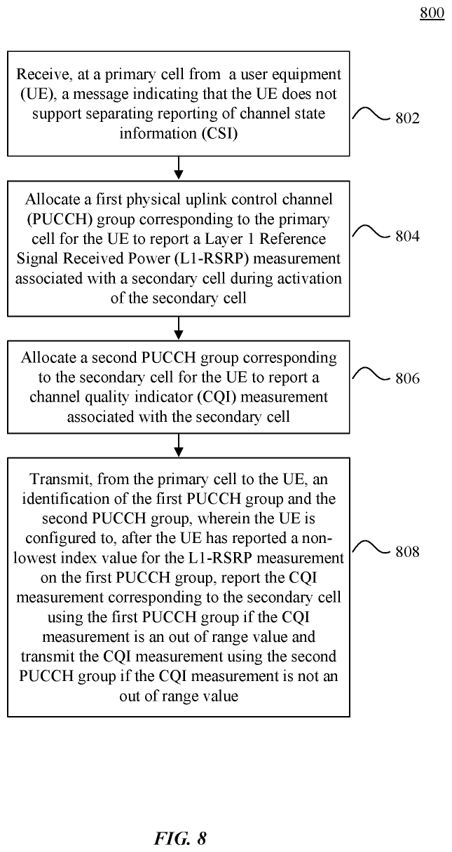

FIG. 8 illustrates an example method for a system (for example, a base station) allocating two PUCCH groups for a UE to report CSI measurements based on the value of the CSI measurement when the UE is not capable of report separation, according to some aspects of the disclosure. As a convenience and not a limitation, FIG. 8 may be described with regard to elements of FIGS. 1A-1B. Method 800 may represent the operation of a base station (for example, PCell 130 or PSCell 150 of FIG. 1A or base stations 130 or 150 of FIG. 1B) implementing CSI reporting for PUCCH activation for SCell 140. As previously explained, the term “primary cell” may refer to PCell 130 or PSCell 150. The term “secondary cell” may refer to SCell 140. Method 800 may also be performed by system 200 of FIG. 2 and/or computer system 900 of FIG. 9. But method 800 is not limited to the specific aspects depicted in those figures and other systems may be used to perform the method as will be understood by those skilled in the art. It is to be appreciated that not all operations may be needed, and the operations may not be performed in the same order as shown in FIG. 8.

At 802, a primary cell may receive, from a UE 170, a message indicating that UE 170 does not support separating reporting of channel state information (CSI). This may correspond to 306 or 406 as described with reference to FIG. 3A and FIG. 4A respectively.

At 804, the primary cell may allocate a first PUCCH group corresponding to the primary cell for UE 170 to report a L1-RSRP measurement associated with a secondary cell during activation of the secondary cell. At 806, the primary cell may allocate a second PUCCH group corresponding to the secondary cell for UE 170 to report a CQI measurement associated with the secondary cell. At 808, the primary cell may transmit to UE 170 an identification of the first PUCCH group and the second PUCCH group. After UE 170 has reported a non-lowest index value for the L1-RSRP measurement on the first PUCCH group, UE 170 may report the CQI measurement associated with the secondary cell using the first PUCCH group if the CQI measurement is an OOR value and transmit the CQI measurement using the second PUCCH group if the CQI measurement is not an OOR value. In some aspects, the primary cell may transmit a message instructing UE 170 to perform this reporting. In some aspects, UE 170 may implement a switching rule and may autonomously switch from the first PUCCH to the second PUCCH group. For example, this switching rule may be executed by UE 170 without an instruction from the primary cell.

Similar to method 700, this process may preconfigure CSI reporting for UE 170. As explained with reference to method 700, UE 170 may use a TDM configuration to separate reporting of the L1-RSRP measurement and the CQI measurement. UE 170 may further separate the CQI reporting into two period. This may depend on a condition or the particular value of the CQI. If UE 170 determines that the CQI measurement is OOR, UE 170 may report this value using the first PUCCH group corresponding to the primary cell. If UE 170 reports a valid CQI or a non-OOR CQI, UE 170 may report this value using the second PUCCH group corresponding to the secondary cell. This may be an automatic switch at UE 170 based on the preconfiguration provided by the primary cell.

Various aspects can be implemented, for example, using one or more computer systems, such as computer system 900 shown in FIG. 9. Computer system 900 can be any well-known computer capable of performing the functions described herein such as devices 130, 140, 150, 170 of FIG. 1A and FIG. 1B, and/or 200 of FIG. 2. Computer system 900 includes one or more processors (also called central processing units, or CPUs), such as a processor 904. Processor 904 is connected to a communication infrastructure 906 (e.g., a bus). Computer system 900 also includes user input/output device(s) 903, such as monitors, keyboards, pointing devices, etc., that communicate with communication infrastructure 906 through user input/output interface(s) 902. Computer system 900 also includes a main or primary memory 908, such as random access memory (RAM). Main memory 908 may include one or more levels of cache. Main memory 908 has stored therein control logic (e.g., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 includes a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 reads from and/or writes to removable storage unit 918 in a well-known manner.

According to some aspects, secondary memory 910 may include other means, instrumentalities or other approaches for allowing computer programs and/or other instructions and/or data to be accessed by computer system 900. Such means, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 enables computer system 900 to communicate and interact with any combination of remote devices, remote networks, remote entities, etc. (individually and collectively referenced by reference number 928). For example, communication interface 924 may allow computer system 900 to communicate with remote devices 928 over communications path 926, which may be wired and/or wireless, and which may include any combination of LANs, WANs, the Internet, etc. Control logic and/or data may be transmitted to and from computer system 900 via communication path 926.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 900, main memory 908, secondary memory 910 and removable storage units 918 and 922, as well as tangible articles of manufacture embodying any combination of the foregoing. Such control logic, when executed by one or more data processing devices (such as computer system 900), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 9. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “aspects” “an example,” “examples,” or similar phrases, indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A primary cell base station, comprising:
a transceiver configured to enable wireless communications with a user equipment (UE), including wireless communications received via a physical uplink control channel (PUCCH); and
a processor communicatively coupled to the transceiver and configured to:
receive, from the UE, a message indicating whether the UE supports separating reporting of channel state information (CSI);
based on the message indicating that the UE supports separating the reporting of CSI:
allocate a first PUCCH group for the UE to report a first CSI measurement of a first CSI resource associated with a secondary cell base station during activation of the secondary cell base station;
allocate a second PUCCH group for the UE to report a second CSI measurement of a second CSI resource associated with the secondary cell base station during activation of the secondary cell base station; and
transmit, to the UE, an identification of the first PUCCH group and the second PUCCH group.

2. The primary cell base station of claim 1, wherein the first PUCCH group corresponds to the primary cell base station and wherein the second PUCCH group corresponds to the secondary cell base station.

3. The primary cell base station of claim 1, wherein the first PUCCH group corresponds to the primary cell base station and wherein the first CSI measurement is a layer-1, reference signal received power (L1-RSRP) measurement.

4. The primary cell base station of claim 1, wherein the second PUCCH group corresponds to the secondary cell base station and wherein the second CSI measurement is a channel quality indicator (CQI).

5. The primary cell base station of claim 1, wherein based on the message indicating that the UE does not support separating the reporting of CSI, the processor is configured to:
allocate a PUCCH group corresponding to the primary cell base station for the UE to report a CSI measurement of a CSI resource associated with the secondary cell base station during activation of the secondary cell; and
transmit, to the UE, an identification of the PUCCH group.

6. The primary cell base station of claim 1, wherein based on the message indicating that the UE does not support separating the reporting of CSI, the processor is configured to:
allocate a first PUCCH group corresponding to the primary cell base station for the UE to report a layer-1, reference signal received power (L1-RSRP) measurement associated with the secondary cell base station during activation of the secondary cell;
allocate a second PUCCH group corresponding to the secondary cell base station for the UE to report a channel quality indicator (CQI) measurement associated with the secondary cell base station;
transmit, to the UE, an identification of the first PUCCH group;
receive a report from the UE that the L1-RSRP measurement is a non-lowest index value; and
in response to receiving the report of the L1-RSRP measurement, transmit, to the UE, an identification of the second PUCCH group.

7. The primary cell base station of claim 1, wherein based on the message indicating that the UE does not support separating the reporting of CSI, the processor is configured to:
allocate a first PUCCH group corresponding to the primary cell base station for the UE to report a layer-1, reference signal received power (L1-RSRP) measurement associated with the secondary cell base station during activation of the secondary cell;
allocate a second PUCCH group corresponding to the secondary cell base station for the UE to report a channel quality indicator (CQI) measurement associated with the secondary cell base station;
transmit, to the UE, an identification of the first PUCCH group and the second PUCCH group, wherein the UE is configured to transmit the CQI measurement using the second PUCCH group after the UE has reported a non-lowest index value for the L1-RSRP measurement using the first PUCCH group.

8. The primary cell base station of claim 1, wherein based on the message indicating that the UE does not support separating the reporting of CSI, the processor is configured to:
allocate a first PUCCH group corresponding to the primary cell base station for the UE to report a layer-1, reference signal received power (L1-RSRP) measurement associated with the secondary cell base station during activation of the secondary cell;
allocate a second PUCCH group corresponding to the secondary cell base station for the UE to report a channel quality indicator (CQI) measurement associated with the secondary cell base station;
transmit, to the UE, an identification of the first PUCCH group and the second PUCCH group, wherein the UE is configured to, after the UE has reported a non-lowest index value for the L1-RSRP measurement on the first PUCCH group, report the CQI measurement using the first PUCCH group if the CQI measurement is an out of range value and transmit the CQI measurement using the second PUCCH group if the CQI measurement is not an out of range value.

9. A method, comprising:
receiving, at a primary cell from a user equipment (UE), a message indicating whether the UE supports separating reporting of channel state information (CSI);
based on the message indicating that the UE supports separating the reporting of CSI:
allocating, by the primary cell, a first PUCCH group for the UE to report a first CSI measurement of a first CSI resource associated with a secondary cell during activation of the secondary cell;
allocating, by the primary cell, a second PUCCH group for the UE to report a second CSI measurement of a second CSI resource associated with the secondary cell during activation of the secondary cell; and
transmitting, by the primary cell to the UE, an identification of the first PUCCH group and the second PUCCH group.

10. The method of claim 9, wherein the first PUCCH group corresponds to the primary cell and wherein the second PUCCH group corresponds to the secondary cell.

11. The method claim 9, wherein the first PUCCH group corresponds to the primary cell and wherein the first CSI measurement is a layer-1, reference signal received power (L1-RSRP) measurement.

12. The method of claim 9, wherein the second PUCCH group corresponds to the secondary cell and wherein the second CSI measurement is a channel quality indicator (CQI).

13. The method of claim 9, wherein based on the message indicating that the UE does not support separating the reporting of CSI, the method further comprises:
allocating, by the primary cell, a PUCCH group corresponding to the primary cell for the UE to report a CSI measurement of a CSI resource associated with the secondary cell during activation of the secondary cell; and
transmitting, by the primary cell to the UE, an identification of the PUCCH group.

14. The method of claim 9, wherein based on the message indicating that the UE does not support separating the reporting of CSI, the method further comprises:
allocating, by the primary cell, a first PUCCH group corresponding to the primary cell for the UE to report a layer-1, reference signal received power (L1-RSRP) measurement associated with the secondary cell during activation of the secondary cell;
allocating, by the primary cell, a second PUCCH group corresponding to the secondary cell for the UE to report a channel quality indicator (CQI) measurement associated with the secondary cell;
transmitting, by the primary cell to the UE, an identification of the first PUCCH group;
receiving, by the primary cell, a report from the UE that the L1-RSRP measurement is a non-lowest index value; and
in response to receiving the report of the L1-RSRP measurement, transmitting, by the primary cell, to the UE, an identification of the second PUCCH group.

15. The method of claim 9, wherein based on the message indicating that the UE does not support separating the reporting of CSI, the method further comprises:
allocating, by the primary cell, a first PUCCH group corresponding to the primary cell for the UE to report a layer-1, reference signal received power (L1-RSRP) measurement associated with the secondary cell during activation of the secondary cell;
allocating, by the primary cell, a second PUCCH group corresponding to the secondary cell for the UE to report a channel quality indicator (CQI) measurement associated with the secondary cell;
transmitting, by the primary cell to the UE, an identification of the first PUCCH group and the second PUCCH group, wherein the UE is configured to transmit the CQI measurement using the second PUCCH group after the UE has reported a non-lowest index value for the L1-RSRP measurement using the first PUCCH group.

16. The method of claim 9, wherein based on the message indicating that the UE does not support separating the reporting of CSI, the method further comprises:
allocating, by the primary cell, a first PUCCH group corresponding to the primary cell for the UE to report a layer-1, reference signal received power (L1-RSRP) measurement associated with the secondary cell during activation of the secondary cell;
allocating, by the primary cell, a second PUCCH group corresponding to the secondary cell for the UE to report a channel quality indicator (CQI) measurement associated with the secondary cell;
transmitting, by the primary cell to the UE, an identification of the first PUCCH group and the second PUCCH group, wherein the UE is configured to, after the UE has reported a non-lowest index value for the L1-RSRP measurement on the first PUCCH group, report the CQI measurement using the first PUCCH group if the CQI measurement is an out of range value and transmit the CQI measurement using the second PUCCH group if the CQI measurement is not an out of range value.

17. A user equipment (UE), comprising:
a transceiver configured to wirelessly communicate with a primary cell and a secondary cell; and
a processor communicatively coupled to the transceiver and configured to:
determine whether the UE supports separating reporting of channel state information (CSI);
based on the UE supporting separating the reporting of CSI:
transmit a message to the primary cell indicating that the UE supports separating the reporting of CSI;
receive an allocation of a first physical uplink control channel (PUCCH) group and a second PUCCH group;
report, using the first PUCCH group, a first CSI measurement of a first CSI resource associated with a secondary cell during activation of the secondary cell; and
report, using the second PUCCH group, a second CSI measurement of a second CSI resource associated with the secondary cell during activation of the secondary cell.

18. The UE of claim 17, wherein the first PUCCH group corresponds to the primary cell and wherein the second PUCCH group corresponds to the secondary cell.

19. The UE of claim 17, wherein the first PUCCH group corresponds to the primary cell and wherein the first CSI measurement is a layer-1, reference signal received power (L1-RSRP) measurement.

20. The UE of claim 17, wherein the second PUCCH group corresponds to the secondary cell and wherein the second CSI measurement is a channel quality indicator (CQI).
